(19) United States
(12) Patent Application Publication
(10) Pub. No.: US 2005/0076242 A1
(43) Pub. Date: Apr. 7, 2005

(54) Wireless access management and control for personal computing devices

(76) Inventor: Rolf Breuer, Cupertino, CA (US)

Correspondence Address: Rolf Breuer, 10356 North Portal Avenue, Cupertino, CA, 95014, US

(21) Appl. No.: 10/789,617

(22) Filed: Feb. 27, 2004

Related U.S. Application Data
(60) Provisional application No. 60/508,132, filed on Oct. 1, 2003.

(51) Int. Cl. H04L 9/00

(52) U.S. Cl. 713/201

(57) ABSTRACT

A wireless access control system for an electronic device comprises a personal locking device and an access control software module. The electronic device and personal locking device are Bluetooth-enabled and use Bluetooth to communicate with each other. The access control software is used to establish a Bluetooth link between these devices, based on the unique Bluetooth identifiers of the personal locking device and the electronic device. The personal locking device is preferably portable and is carried by the user at all times. Examples of preferred personal locking devices are cellular telephones, personal digital assistants, and pocket PCs. The Bluetooth radio chip and the Bluetooth communications protocol monitor the quality of service of the Bluetooth link between the devices. When the quality of service falls below a predetermined threshold, the access control software may switch the electronic device from an unlocked state to a locked state. When the quality of service rises above a predetermined threshold from below the threshold, the software may switch the electronic device from a locked state to an unlocked state.

The present application claims the benefit of U.S. Provisional Application No. 60/508,132, filed on Oct. 1, 2003.

### TECHNICAL FIELD

The present invention relates to access management and control for personal computing devices such as desktop computers, notebook computers, tablet PCs, servers, Personal Digital Assistants (PDA), and PocketPCs.

### BACKGROUND ART

Ever since documents, be it financial data, confidential information, or other personal files, were generated and stored on personal computers (PCs), there has been a need to protect these document from falling in to the “wrong hands”. The computer industry has addressed this problem in a variety of ways, beginning with protecting PC system access with a simple password. The encryption of the data stored on the system's hard drive was the next step. The physical lockup of the system with hardware keys that have to be connected to a PC's serial port was another method.

There are remote control methods for access management. For example, U.S. Pat. No. 6,675,300 discloses a remote controller that can perform remote control of a personal computer. The remote controller has a unique identifier and the PC to be controlled also has the same identifier stored therein. The remote controller and the computer may communicate by infrared (IR) or radio frequency (RF) signals. The identifier is provided for a security function. The computer checks whether the remote controller's identifier matches its own. If there is a match, the remote controller can be used to issue remote control commands to the computer. Signals from other remote controllers are ignored.

U.S. 2002/0056046 A1 discloses a method of switching a computer to a password protected mode when a computer user leaves the proximity of the computer. The system is provided with a proximity sensor, such as ultrasound, infrared, or electromagnetic proximity sensor. In one example, an ultrasound proximity sensor operates as follows: 1) a signal generator generates an electrical signal of a particular frequency; 2) a transducer converts the electrical signal to an ultrasound signal; 3) the ultrasound signal is reflected by the body of the user; 4) the reflected wave strikes the transducer and the transducer converts the reflected ultrasound signal to an electrical signal; 5) a relatively low frequency signal given by the difference in frequency between the signal provided by the signal generator and the signal from the transducer is generated; and 6) the difference signal is used to determine the presence of a person proximate the computer. An alternative proximity sensor detects the weight of a user as an indication of presence of the user in a chair the user sits in to use the computer. Note that this system merely detects the presence of a person and can not distinguish authorized and unauthorized users. Furthermore, it just detects the presence of a person and is not be able to distinguish between authorized and unauthorized users. In addition all necessary hardware seems to be integrated into the keyboard.

Methods for access management have been developed that include wireless or contactless badges. These work like solutions for building access that use badges that do not have batteries and therefore are defined as passive badges. These wireless solutions use radio frequencies mostly in unlicensed frequency spectrums and require the use and installation of a specific transponder called interrogator or reader that works in those frequencies by sending out timed read commands to which the passive, wireless/contactless key responds by sending back its ID number.

U.S. Pat. No. 6,374,145 also discloses the use of a proximity sensor to detect the presence of a person in the vicinity of a computer. This patent also provides for the use of a multidimensional proximity sensor, which is made up of two or more proximity sensors. For example, a multidimensional proximity sensor may comprise a reflectance sensor of the type discussed above with reference to U.S. 2002/0056046 A1 and a RF sensor which identifies RF ID tags that are worn by authorized users.

U.S. Pat. No. 6,070,240 provides methods for computer access control. In these methods, a computer has a database of authorized users and a RF transceiver. Each authorized user of the computer carries a portable RF transponder (badge with built-in RFID chip) which has an authorized user code. The computer's RF transceiver continuously scans the operating space of the computer for the presence of authorized users by sending out read command in defined intervals. The operating space is the space near the computer in which a user would be located while using the computer. The space is defined by the specific technology used for these solutions. Scanning comprises the following steps: 1) the RF transceiver emits a signal; 2) a user places a portable transponder in the operating space of the computer (close to the RF transceiver); 3) the transponder is energized by the signal from the RF transceiver, and responds by sending a signal containing the authorized user code and/or ID number; 4) the computer compares the authorized code from the transponder to the database of authorized users; and 5) if there is a match, the computer is unlocked for the user to use. Note that this method requires continuous scanning (the periodic and continuous transmission of identifiers). Furthermore, the method requires that a database of authorized users be maintained at the computer.

Similarly, U.S. Pat. No. 6,189,105 discloses systems and methods that include continuous scanning of the operating space of a computer for the presence of an authorized user code, such as a proximity badge worn on a person. The interrogating signal may be RF or infrared (IR). Furthermore, these systems and methods include continuous detection of the presence of a person, such as by detection of keystrokes on the keyboard, reading the barcode on the badge a person is wearing by means of an infrared signal to an infrared detector by the body of a person, or the interference with a transmitted RF signal.

U.S. 2003/0030542 A1 discloses security systems for portable electronic devices such as personal digital assistants (PDAs) and laptop computers. The portable electronic device has a RF transmitter that emits an interrogation signal; in response to this interrogation signal, a portable electronic key worn by a person, which contains a password, emits a signal containing the password; and upon receipt of the password, the portable electronic device is unlocked. In order to make this security system work, the RF transmitter must transmit an interrogation signal periodically, such as once per minute. This ensures that the portable electronic device will be disabled when the portable electronic key is no longer within the range of the portable electronic device.

U.S. 2003/0034877 discloses devices and methods for providing access control for electronic systems based on proximity detection. Examples of electronic systems include a computer, a kiosk, a set-top box, a teller machine, a cash register, and control equipment. An electronic system includes a transceiver for transmitting and receiving wireless messages (e.g. RF, infrared). Authorized users of the electronic system carry an identifier (e.g. badge, key fob, magnetic card, belt buckle, watch). Wireless communication between the transceiver and the portable identifier is accomplished using protocols such as Bluetooth, IEEE 802.11b (WiFi), and Digital Enhanced Cordless Telecommunications (DECT). Furthermore, the electronic system is equipped with a distance determination agent, which determines the distance between the transceiver and the portable identifier. In the case of Bluetooth, which is a low power communications protocol, a message from the identifier may be received by the electronic system only when the identifier is in close proximity (30 feet line of sight defined by the protocol specifications) to the electronic system. In the case of higher power protocols, such as Home RF, the distance determination agent may determine the distance by monitoring the time between the transmission of a message from the electronic system to the receipt of a reply or reflected signal from the identifier. The distance can also be measured with alternative methods such as global positioning satellite (GPS) signals, triangulation, or infrared signaling. An important drawback to these methods is that there is a need for periodic and continuous scanning of the operating space to determine the distance between the electronic system and the identifier.

In summary, prior art access control systems and methods, while providing varying levels of security, are generally inconvenient to the user and expensive to implement. If a computer could be remote controlled by a remote controller, the user must explicitly issue commands from the remote controller. Systems and methods that rely on proximity sensors can generally identify the presence of a person or an object in the operating space of the computer, but cannot distinguish authorized and unauthorized users. Systems and methods that rely on RFID technology can identify authorized users, but require continuous and periodic scanning of the operating space including transmission of messages that contain the unique identifier or password.

### SUMMARY OF THE INVENTION

The present invention relates to access control management for computing devices such as a notebook computer, a desktop computer, a server, or a tablet PC. It takes a new, convenient and secure approach to protecting data from prying eyes and theft by locking the above listed devices into a secure mode and rendering them useless for users that are not unauthorized to use the devices. Only when a wireless identifier key, carried by the authorized user is brought into the space of the protected computing device, the device will unlock and allows access to functions and files for this user. Other key elements of the invention are: a) simple implementation of the system into the computing device, b) use of standard electronic components for the identifier key, c) readily available wireless communication ports already built into the computing devices, and d) employing integral functions that are built into the standard communications protocol(s) used for the invention.

One of the important limitations of prior art methods is that significant investment in additional hardware, such as identification badges, proximity sensors, remote controllers, RF transceivers, and GPS systems, is required. Therefore, an objective of the present invention is to minimize investment in additional hardware. The present invention uses Bluetooth to establish a secure link between a personal computing device and a mobile electronic device (used as identifier key). Mobile electronic devices such as cellular telephones and personal digital assistants (PDAs) have recently proliferated to the extent that many computer users already own and carry mobile electronic devices. In general, users of such mobile electronic devices become accustomed to carrying them around at all times. Furthermore, mobile electronic devices that are Bluetooth-enabled are becoming more widely available. Personal computing devices (e.g. notebook computers, desktop computers, servers, tablet PCs, PDAs) that are Bluetooth-enabled are also becoming more widely available. In cases where a computing device is not yet Bluetooth-enabled, it is relatively inexpensive and straightforward to install a Bluetooth dongle in the USB port of the computing device. Such a Bluetooth dongle is relatively inexpensive because Bluetooth is a standard communication protocol that has become widely available as a replacement for physical cable connections.

Another limitation of some prior art systems and methods is that identification means to identify an authorized user are not provided. Each Bluetooth device is identified by a unique identifier, called the Bluetooth address. With the present invention, selected Bluetooth-enabled mobile devices can be employed as personal locking devices. It is highly likely that users will remember to carry their mobile devices on them at all times, and it is also highly likely that they will notice immediately if such mobile devices are lost or stolen. In effect, these Bluetooth-enabled mobile devices can function as unique identifiers of authorized users.

Yet another limitation of some prior art systems and methods is that there is a need for periodic and continuous scanning of the operating space of the computing device to determine the presence of an authorized user. This holds true for RFID, proximity sensors, and infrared scanning technologies. Using these scanning methods also comprises continuous and periodic transmission of an identifier or password. In contrast, the present invention eliminates the need for continuous and periodic scanning. In the systems and methods of the present invention, a wireless communications link is established using the Bluetooth protocol. In one embodiment, the link is maintained for as long the quality-of-service of the link is above a predetermined threshold. The quality of service may fall below the threshold, for example, if the Bluetooth-enabled mobile device is moved to a location that is not proximate to the computing device. Even in this case a virtual connection between the two devices still exists and is maintained by the Bluetooth protocol until the mobile device is brought back within physical range and the quality-of-service threshold is crossed again. While all of this is going on, the unique identifier number is only transmitted once during the initial establishment of the communication between the two devices.

Yet another limitation of some prior art systems and methods is that the computing device must maintain a list of authorized users. In the present invention, no databases are necessary. In the present invention, the computing device is introduced to a personal locking device, and a wireless link between them is established. The computing device does not concurrently maintain wireless links with other personal locking devices.

Yet another advantage of the present invention is that personal locking devices may be used to lock/unlock multiple devices, such as computers in the office and computers at home. Furthermore, protected devices need not be limited to computers. Bluetooth-enabled devices that are capable of running the access control software can be similarly protected or controlled. Protected devices may include household appliances such as garage door openers, gates and doors, refrigerators, home entertainment systems, media servers, and television receivers.

In one aspect, the present invention provides an access control system comprising: a protected device, a personal locking device, and an intelligent access control key software residing on the protected device. The protected device and personal locking device are both Bluetooth-enabled. Other possible communication protocols include but are not limited to ZigBee (IEEE 802.15.4) and Ultra Wide Band (IEEE 802.15.3). These can also be used as they become available for mass market applications.

In another aspect, the present invention provides an access control software which is installed on a device to be protected. The access control software establishes a wireless link between a protected device and a personal locking device. The software monitors the quality of service of the link; whenever the quality of service falls below a predetermined threshold, the software instructs the computer to take a protective action, such as putting the computer in a locked mode. If the quality of service was below a predetermined threshold and then improves above the threshold, the software instructs the computer to switch from the locked state to an unlocked state.

In yet another aspect, the present invention provides a personal locking device that is, at this time, using Bluetooth as communications vehicle. The device also has a user input to allow the user to manually place the computer in a locked state.

In yet another aspect, the present invention provides a method of access control, comprising the steps of: providing a device to be protected; enabling Bluetooth in the to-be-protected device; providing a personal locking device; enabling Bluetooth in the personal locking device; positioning the personal locking device in the operating space of the device to be protected; installing an access control software on the device to be protected; establishing a Bluetooth link between the device to be protected and the personal locking device using the unique hardware Bluetooth identifiers of the 2 devices; and taking a protective action on the protected device whenever the quality of service of the Bluetooth link falls below a predetermined threshold.

Other advantages and features of the present invention will become apparent in the detailed discussion below.

### BRIEF DESCRIPTION OF THE FIGURES

The present invention is described in detail with reference to the following Figures.

FIG. 1A is a schematic illustration of a 1st embodiment of the present invention.

FIG. 1B is a schematic illustration of a 2nd embodiment of the present invention.

FIG. 1C is a schematic illustration of a 3rd embodiment of the present invention.

FIG. 2A is a schematic diagram of a 1st embodiment of a personal locking device in accordance with the present invention.

FIG. 2B is a schematic diagram of a 2nd embodiment of a personal locking device in accordance with the present invention.

FIG. 3A shows a message on a computer monitor window with the 2 lock options in accordance with an embodiment of the present invention.

FIG. 3B is a flowchart illustrating the operation of the access control system in accordance with the present invention.

### DETAILED DESCRIPTION OF THE INVENTION

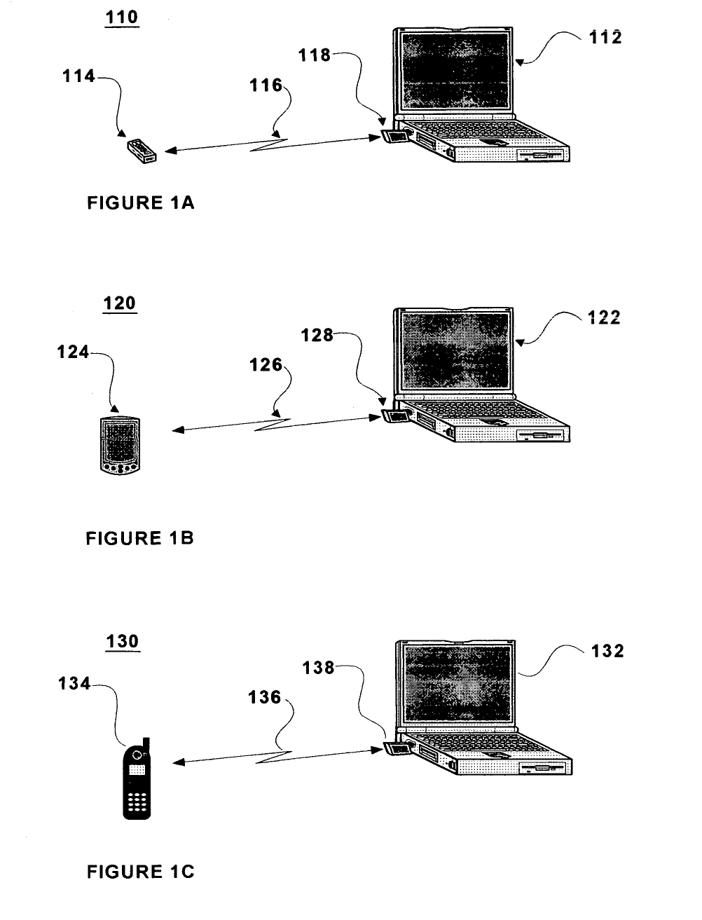

FIG. 1A illustrates a system in accordance with the 1st embodiment of the present invention. System 110 comprises a personal computing device 112 and a dedicated personal locking device (PLD) 114. In FIG. 1A, personal computing device 112 is shown as a notebook computer; however, it may also be a tablet PC, desktop PC, or a server. The personal computing device is the device for which access control and management is to be provided in this invention. In general, the personal computing device is too large or heavy for the authorized user to carry on his person at all times. In contrast, personal locking device 114 is generally small and light enough for the user to carry with him at all times. Also shown in FIG. 1A is a Bluetooth dongle 118 that is shown positioned in a USB port of personal computing device 112. This arrangement is required in the case that personal computing device 112 does not have Bluetooth capability integrated within. However, if personal computing device 112 does have Bluetooth capability already, Bluetooth dongle 118 is unnecessary for implementing this invention. A secure wireless link 116 is established between the Bluetooth radio of personal locking device 114 and the Bluetooth radio of Bluetooth dongle 118. A key element in this wireless access control management system is that it employs the standard Bluetooth communications protocol to establish, maintain and manage a secure and encrypted communications link between the personal computing device and the personal locking device.

FIG. 1B illustrates a system in accordance with a 2nd embodiment of the present invention. System 120 comprises a personal computing device 122, a Bluetooth enabled personal digital assistant (PDA) or Pocket PC handheld computer 124, and (if necessary) a Bluetooth dongle 128 that is attached to personal computing device 122. A secure wireless link 126 is established between the Bluetooth-enabled PDA or Pocket PC 124 and Bluetooth dongle 128. In this embodiment, the personal locking device is a dual-purpose personal locking device, which serves the functions of a personal locking device and that of a PDA or a Pocket PC. A commercially available PDA or Pocket PC, with Bluetooth enabled, functions as a dual-purpose personal locking device when incorporated into the system according to the present invention.

FIG. 1C illustrates a system in accordance with the 3rd embodiment of the present invention. System 130 comprises a personal computing device 132, Bluetooth-enabled cellular telephone or Smartphone 134, and a Bluetooth dongle 138 that is attached to personal computing device 132. A secure wireless link 136 is established between the Bluetooth-enabled cellular telephone 134 and Bluetooth dongle 138. In this embodiment, the personal locking device is a dual-purpose personal locking device, which serves the functions of a personal locking device and that of a cellular telephone or Smartphone. A commercially available cellular telephone or Smartphone, with Bluetooth enabled, functions as a dual-purpose personal locking device when incorporated into the system according to the present invention.

An advantage of using the standard Bluetooth protocol is that many of today's PCs, PDAs, Pocket PCs, Smartphones, and cell phones are already equipped with Bluetooth radio hardware. Devices with USB ports such as PCs can easily be retrofitted with a Bluetooth radio by attaching a USB Bluetooth dongle, hence eliminating the need for a special transponder. Devices such as PDAs and cell phones can also be retrofitted with Bluetooth add-on cards.

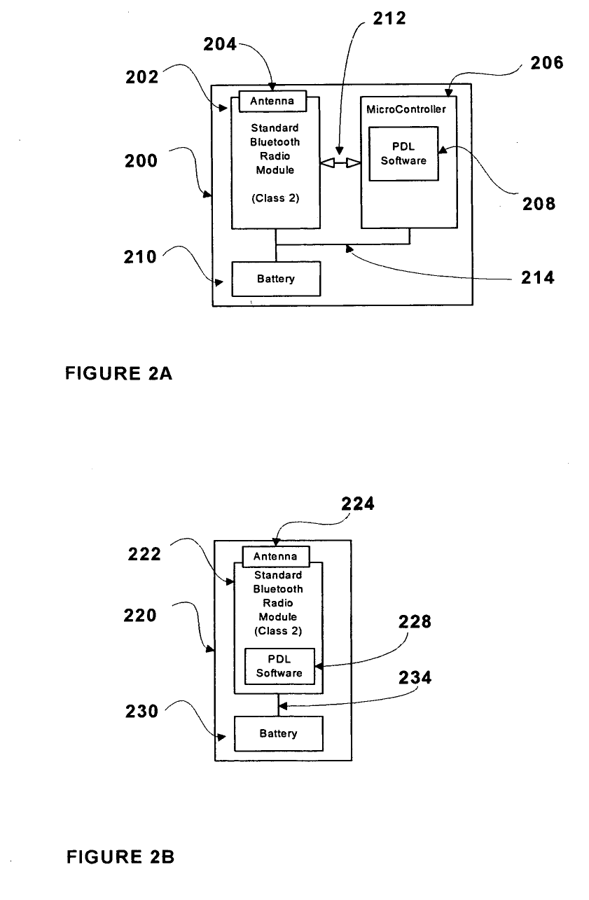

Examples of devices that can function as a personal locking device are personal digital assistants (PDAs), Pocket PC handheld computers, Smartphones, and cellular telephones. A PDA may use the Palm Operating System. A Pocket PC handheld computer may use the Microsoft Windows operating system for these classes of devices. Another example is a Bluetooth-enabled key chain. As discussed above, it is also possible to use dedicated personal locking devices (FIG. 1A, element 114). FIG. 2A illustrates a 1st embodiment of a personal locking device in accordance with the present invention. Personal locking device 200 comprises a standard Bluetooth radio module 202, an antenna 204 connected to module 202, a microcontroller 206, and a battery 210. Battery 210 powers the components in the device via lines 214. A personal locking device (PLD) software 208 is installed on microcontroller 206, and is used to control Bluetooth radio module 202. Module 202 and microcontroller 206 have electrical connections 212.

FIG. 2B illustrates a 2nd embodiment of a personal locking device in accordance with the present invention. Personal locking device 220 comprises a standard Bluetooth radio module 222, an antenna 224 connected to module 222, and a battery 230. Battery 230 powers the components in the device via lines 234. A personal locking device (PLD) software 228 is installed in Bluetooth module 222. Therefore, in this case the PLD software is fully integrated and stored in the Bluetooth radio module. It should be noted that in dual-purpose personal locking devices (FIG. 1B, element 124 and FIG. 1C, element 134), no additional PLD software is required on the personal locking devices.

Additional embodiments of the present invention include those in which the device to be protected is an electronic device that is not a personal computing device. For example, it may be desirable to control access to cars, garages, houses, and buildings. In the case of a garage, the device to be protected could be the garage door opener instead of a personal computing device. The garage door opener must also be equipped to establish a Bluetooth link with a personal locking device. For example, the garage door opener may be connected to a Bluetooth-enabled PC in the house.

An important component of the invention is a software program, called Intelligent Access Control Key (abbreviated IACK) that is installed and runs on a personal computing device. In its mode of operation, the IACK program either prohibits or permits access to files and programs on the personal computing device depending upon the quality of service of the wireless link between the personal computing device and the personal locking device (PLD) that is associated with the personal computing device.

When the IACK software is properly configured, the protected personal computing device will allow access to its files and programs when a wireless link between the personal computing device and the respective Bluetooth-enabled personal locking device has a quality of service greater than a predetermined threshold. Otherwise the personal computing device is in a lock-down mode that appears to the unauthorized user as being a password-protected system. In other words, the PLD is used as a hardware locking and unlocking device for the personal computing device.

The personal computing device may become accessible or unlocked if a wireless link has been established between the two devices and the quality of service of that link is greater than a predetermined threshold. In general, the quality of service depends upon the distance between the Bluetooth-enabled devices. The maximum distance that the PLD can be away from the personal computing device without causing the personal computing device to become locked is determined by the RF radio range and lies within the parameters pursuant to the Bluetooth communications protocol standards specification.

The personal computing device comprises hardware, an operating system, Intelligent Access Control Key (IACK) software, and a Bluetooth-enabled radio transceiver that is either integrated into the unit or attached to it via a standard USB connector (USB Bluetooth dongle). The authorized user of the computing device can configure his system access method (type of personal locking device) and protection level (automatic or manual) by using the IACK software.

We now describe a method of introducing a personal locking device (PLD) to a host personal computing device. First, the user installs the IACK software on the personal computing device. The user also places a PLD in the operating space of the personal computing device. The operating space is the general space where the user and the user's PLD would be located while using the personal computing device. The user then runs the IACK program and starts a search for the PLD. When a PLD is found it is displayed by its name in the window of the IACK software. The user can select this device with a button click and from that point those two devices (the personal computing device and the PLD) are linked to each other by their unique Bluetooth identification numbers. The management of this connection is all done in the Bluetooth radio chipsets and is defined by the Bluetooth protocol specification.

It should be noted that in accordance with the present invention, the Bluetooth addresses (equivalent to the Ethernet MAC numbers) are transferred only once when the devices are introduced to each other at the time configuration. Therefore, there is no need to continuously broadcast identifiers as in prior art devices.

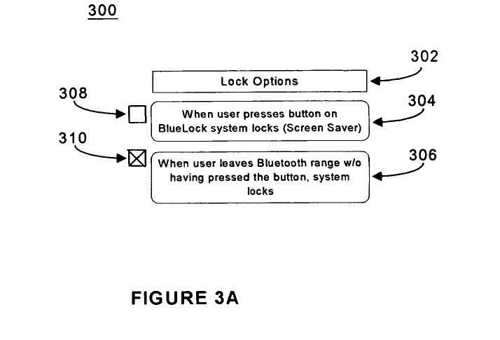

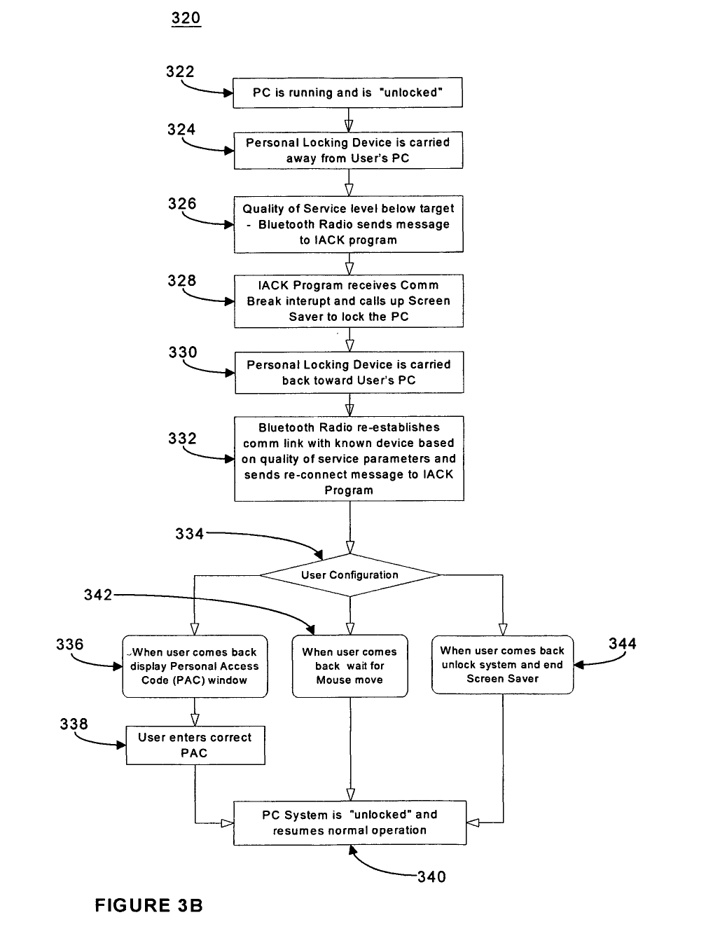

In a 2nd part of the configuration process, the user selects locking options. The computing device may present the options on the computer monitor as shown in FIG. 3A. The user sees a window 300, which is a page with a title “Lock Options” (302). For example, there may be 2 locking options: 1) lock when the personal locking device leaves the Bluetooth range and the quality of service falls below a predetermined threshold (automatic locking option, element 306); and 2) lock when the user presses a predetermined button on the personal locking device (manual locking option, element 304). Window 300 has fields 308 and 310 for letting the user select 1 of the 2 options. In the case that is illustrated in FIG. 3A, the user has selected the automatic locking option. The manual locking option may be available in dedicated personal locking devices, in which a button may be provided for manual locking.

In a 3rd part of the configuration process, the user selects unlocking options. The user may be asked to choose from among 3 unlocking options: 1) unlock when the quality of service of the link returns to above a predetermined threshold (automatic unlocking option); 2) prepare to unlock when the quality of service of the link returns to above a predetermined threshold and unlock when there is an input from an input device, such as movement of the mouse (user input unlocking option); and 3) prepare to unlock when the quality of service of the link returns to above a predetermined threshold, present a window requesting a user to input a personal access code (PAC), and unlock when the code that is input in response that request matches the correct PAC (PAC unlocking option). If the user has chosen the manual locking option, then it is also possible to unlock when the user presses a predetermined button on the personal locking device. The manual unlocking option may be available in dedicated personal locking devices, in which a button may be provided for manual unlocking. This button may be the same as the manual locking button, in which case the button acts as a toggle switch. The user may also be asked to approve or modify a predetermined quality of service threshold. Additionally, at the time of initial configuration of the IACK software, the user determines a personal access code (PAC) that is to be used for the PAC unlocking option described above.

In the automatic locking mode, the personal computing device remains unlocked for the user as long as the quality of service of the Bluetooth communication link is above a predetermined threshold. The Bluetooth radio continuously measures the quality of service (signal strength) and compares it to the quality of service parameters that had been set during the user configuration. No action from the host personal computing device is needed.

In summary, there are 2 methods of locking a personal computing device:
(1) Automatic locking: Take the PLD and walk away from the personal computing device. When the radio connection between the two devices deteriorates to a degree at which the quality of service parameters fall below predetermined levels, a signal is sent to the IACK software that runs in the personal computing device that triggers the device to automatically go into the configured lockup state.
(2) Manual locking: Push the “lock” button on the PLD, which sends a message to the personal computing device to go into the locked state. This key configuration has been configured in the IACK software. Pressing the button again can unlock the system. In the manual locking mode, the automatic locking mode is also active.

FIG. 3B is a flowchart 320 illustrating the various steps in locking and unlocking a personal computing device in the automatic locking mode. In step 322, the personal computing device is running and is unlocked. The authorized user is in the operating space of the personal computing device and the wireless link between the PLD and the personal computing device has a quality of service greater than a predetermined threshold.

In step 324, the PLD is carried away from the operating space. As a result, in step 326, the quality of service falls below a predetermined threshold. In response, the Bluetooth radio sends a message to the IACK program reporting this change. In step 328, the IACK program receives this message and executes a screen saver program to lock the personal computing device.

In step 330, the PLD is carried back toward the operating space. When the IACK software-equipped personal computing device is in lock-down mode it is set to expect a message from the Bluetooth radio controller. The Bluetooth radio controller controls and manages the radio connection to external Bluetooth devices. If the Bluetooth radio controller detects a PLD-specific radio signal and that signal is within the set specifications for signal strength and quality of service, it checks whether it had initialized a link with that device before. If it had initialized a link before, it reestablishes the radio link with the device. These actions are part of the Bluetooth communications link management that is controlled by the Bluetooth chip (set). A message is then sent to the IACK program reporting that the link has been reestablished (step 332). Note that if an unauthorized PLD were placed in the operating space, it and the personal computing device would not be able to establish a wireless link.

Upon receiving this message, the IACK program selects from among 3 options based on the user configuration (step 334). There are 3 options: a PAC unlocking option, a user input unlocking option, and an automatic unlocking option. In the automatic unlocking option (step 344), the personal computing device will automatically unlock and display the user's desktop screen. In the user input unlocking option (step 342), the personal computing device unlocks automatically when a user input (e.g. mouse movement) is detected. In the PAC unlocking option (step 336), the personal computing device will display a Personal Access Code window in which the user can enter his personal access code (step 338). If the code matches the data saved in the user configuration of the IACK software, the personal computing device will unlock and display the user's desktop.

Alternatively, the PAC window may be displayed on the computer monitor whenever the PLD is out of range and a keyboard action or mouse movement has been detected. Therefore, the authorized user may enter the correct PAC and gain access to the personal computing device without having the PLD.

It should be understood that security can be enhanced further within the scope of this invention by installing additional hardware or software. Software applications can be installed on personal locking devices (e.g. PDAs, Pocket PCs, cell phones, Smartphones) that link the devices to the IACK software in the personal computing device. Additional code or a plug-in may be installed in the operating systems (e.g. Palm Operating System, Microsoft) of these devices. Additional hardware may be provided in these devices to link them to IACK software.

1. A system for controlling access to files and application programs on a personal computing device, comprising:
A) a personal locking device comprising a 1st wireless data communication device, said 1st wireless data communication device having a 1st unique identifier associated therewith and having a capability to establish a wireless data link by a wireless communications protocol; and
B) a 2nd wireless data communication device integrated into or attached to said personal computing device, said 2nd wireless data communication device having a 2nd unique identifier associated therewith and having a capability to establish a wireless data link by said wireless communications protocol;
wherein said 1st and 2nd wireless data communication devices are configured to establish a wireless data link to each other based upon an exchange of said 1st and 2nd unique identifiers, and
said 2nd wireless data communication device is configured to monitor the quality of service of said wireless link and send a message to said personal computing device when said quality of service falls below a predetermined threshold.

2. The system of claim 1, wherein said personal computing device is selected from the group consisting of: notebook computers, desktop computers, tablet PC computers, server computers, personal digital assistants, and PocketPCs.

3. The system of claim 1, wherein said wireless data communication devices are radio frequency communication devices, said wireless data link is a radio frequency data link, and said wireless communications protocol is a radio frequency communications protocol.

4. The system of claim 1, wherein said wireless data communication devices are Bluetooth data communication devices, said wireless data link is a Bluetooth data link, said wireless communications protocol is the Bluetooth communications protocol (IEEE 802.15), and said unique identifiers are Bluetooth device identification numbers that are uniquely assigned to each Bluetooth radio.

5. The system of claim 4, wherein said 2nd Bluetooth data communication device comprises a Bluetooth radio integrated into said personal computing device or a Bluetooth dongle that is attached to a port of said personal computing device.

6. The system of claim 1, wherein said personal locking device is selected from the group consisting of: cell phones, Smartphones, Pocket PC portable computers, and personal digital assistants (PDAs).

7. The system of claim 4, wherein said 1st Bluetooth data communication device comprises a Bluetooth radio module.

8. The system of claim 7, wherein said 1st Bluetooth data communication device additionally comprises a microcontroller and a software installed on said microcontroller for controlling said Bluetooth radio module.

9. The system of claim 7, wherein said 1st Bluetooth data communication device additionally comprises a software program for controlling said Bluetooth radio module.

10. The system of claim 1, wherein said personal locking device additionally comprises a user input means for sending a message to said 2nd wireless communications device.

11. The system of claim 10, wherein said user input means is selected from the group consisting of: a button, a switch, a dial, a touchpad, a keyboard, and a fingerprint sensor.

12. The system of claim 10, wherein said message is a message that requests said personal computing device to go into a locked state in which access to its files and application programs is prohibited or restricted.

13. The system of claim 10, wherein said message is a message that requests said personal computing device to go into an unlocked state.

14. The system of claim 10, wherein said message is a message that requests said personal computing device to go into an unlocked state upon receipt of a user input at said personal computing device.

15. The system of claim 14, wherein said user input comprises a correct personal access code (PAC) or inputs at the keyboard or mouse associated with said personal computing device.

16. The system of claim 1, additionally comprising an access control software program installed on said personal computing device, said software program comprising:
A) a means to configure said 1st and 2nd wireless communication devices to establish said wireless link between them;
B) a means to receive messages from said 2nd wireless communication device; and
C) a means to place, in response to a message from said 2nd wireless communication device, said personal computing device in a locked state in which access to its files and application programs is prohibited or restricted.

17. The system of claim 16, wherein said software program additionally comprises a means to configure said 2nd wireless communication device to monitor said quality of service of said wireless link.

18. The system of claim 16, wherein said software program additionally comprises a means to place, in response to a message from said 2nd wireless communication device, said personal computing device in an unlocked state.

19. The system of claim 16, wherein said software program additionally comprising a means to place, in response to a message from said 2nd wireless communication device and a user input to said personal computing device, said personal computing device in an unlocked state.

20. The system of claim 19, wherein said user input comprises a correct personal access code (PAC) or inputs at the keyboard or mouse associated with said personal computing device.

21. A method for controlling access to files and application programs on a personal computing device, comprising the steps of:
A) providing a personal locking device comprising a 1st wireless data communication device, said 1st wireless data communication device having a 1st unique identifier associated therewith and having a capability to establish a wireless data link by a wireless communications protocol;
B) positioning said personal locking device in the operating space of said personal computing device;
C) providing a 2nd wireless data communication device integrated into or attached to said personal computing device, said 2nd wireless data communication device having a 2nd unique identifier associated therewith and having a capability to establish a wireless data link by said wireless communications protocol;
D) configuring said 1st and 2nd wireless data communication devices to establish a wireless data link to each other based upon an exchange of said 1st and 2nd unique identifiers, thereby authorizing said personal locking device for said personal computing device;
E) configuring said 2nd wireless data communication device to monitor the quality of service of said wireless link and send a message to said personal computing device when said quality of service falls below a predetermined threshold;
F) establishing said wireless data link;
G) monitoring said quality of service of said wireless data link; and
H) sending said message when said quality of service falls below said predetermined threshold.

22. The method of claim 21, additionally comprising the steps of:
A) requesting a user to establish a personal access code (PAC);
B) receiving said code and associating said code with said wireless link; and
C) storing said code in said personal computing device.

23. The method of claim 21, additionally comprising the steps of:
A) positioning a personal locking device in the operating space of said personal computing device;
B) determining whether said personal locking device is an authorized personal locking device for said computing device;
C) establishing a wireless data link between said 2nd wireless data communication device and the wireless data communication device of said personal locking device;
D) monitoring the quality of service of said wireless data link;
E) receiving a message from said 2nd wireless communication device when said quality of service rises above a predetermined threshold; and
F) placing said personal computing device in an unlocked state in response to said message.

24. The method of claim 21, additionally comprising the steps of:
A) positioning a personal locking device in the operating space of said personal computing device;
B) determining whether said personal locking device is an authorized personal locking device for said computing device;
C) establishing a wireless data link between said 2nd wireless data communication device and the wireless data communication device of said personal locking device;
D) monitoring the quality of service of said wireless data link;
E) receiving a message from said 2nd wireless communication device when said quality of service rises above a predetermined threshold;
F) detecting a user input at said personal computing device; and
G) placing said personal computing device in an unlocked state in response to said message and said detection of user input.

25. The method of claim 24, wherein said step of detecting user input comprises detecting keystrokes at the keyboard or movement or clicking at the mouse associated with said personal computing device.

26. The method of claim 21, additionally comprising the steps of:
A) positioning a personal locking device in the operating space of said personal computing device;
B) determining whether said personal locking device is an authorized personal locking device for said computing device;
C) establishing a wireless data link between said 2nd wireless data communication device and the wireless data communication device of said personal locking device;
D) monitoring the quality of service of said wireless data link;
E) receiving a message from said 2nd wireless communication device when said quality of service rises above a predetermined threshold;
F) requesting a user to input a personal access code;
G) receiving said user input;
H) comparing said user input to the personal access code that is stored in said personal computing device; and
I) placing said personal computing device in an unlocked state if there is a match between said input and said stored personal access code.

27. The method of claim 21, wherein said personal computing device is selected from the group consisting of: notebook computers, desktop computers, tablet PC computers, server computers, personal digital assistants, and PocketPCs.

28. The method of claim 21, wherein said wireless data communication devices are radio frequency communication devices, said wireless data link is a radio frequency data link, and said wireless communications protocol is a radio frequency communications protocol.

29. The method of claim 21, wherein said wireless data communication devices are Bluetooth data communication devices, said wireless data link is a Bluetooth data link, said wireless communications protocol is the Bluetooth communications protocol (IEEE 802.15), and said unique identifiers are Bluetooth device identification numbers that are uniquely assigned to each Bluetooth radio.

30. The method of claim 29, wherein said 2nd Bluetooth data communication device comprises a Bluetooth radio integrated into said personal computing device or a Bluetooth dongle that is attached to a port of said personal computing device.

31. The method of claim 21, wherein said personal locking device is selected from the group consisting of: cell phones, Smartphones, Pocket PC portable computers, and personal digital assistants (PDAs).

32. The method of claim 29, wherein said 1st Bluetooth data communication device comprises a Bluetooth radio module.

33. The method of claim 32, wherein said 1st Bluetooth data communication device additionally comprises a microcontroller for controlling said Bluetooth radio module.

34. The method of claim 32, wherein said 1st Bluetooth data communication device additionally comprises a software program for controlling said Bluetooth radio module.

35. The method of claim 21, wherein said personal locking device additionally comprises a user input means for sending messages to said 2nd wireless communications device.

36. The method of claim 35, wherein said user input means is selected from the group consisting of: a button, a switch, a dial, a touchpad, a keyboard, and a fingerprint sensor.

37. The method of claim 35, additionally comprising the steps of:
A) sending a message requesting said personal computing device to go into a locked state in which access to its files and application programs is prohibited or restricted; and
B) placing said personal computing device in a locked state.

38. The method of claim 35, additionally comprising the steps of:
sending a message requesting said personal computing device to go into an unlocked state; and
placing said personal computing device in an unlocked state.

39. The method of claim 35, additionally comprising the steps of:
sending a message requesting said personal computing device to go into an unlocked state;
receiving a user input at said personal computing device; and placing said personal computing device in an unlocked state upon receipt of said message and said user input.

40. The method of claim 39, wherein said step of receiving user input comprises detecting keystrokes at the keyboard or movement or clicking of the mouse associated with said personal computing device.

41. The method of claim 35, additionally comprising the steps of:
A) sending a message requesting said personal computing device to go into an unlocked state;
B) requesting a user to input a personal access code;
C) receiving said users input;
D) comparing said input to the personal access code that is stored in said personal computing device; and
E) placing said personal computing device in an unlocked state if there is a match between said input and said stored personal access code.

42. The method of claim 21, additionally comprising the steps of:
A) installing an access control software program on said personal computing device;
B) using said program to configure said 1st and 2nd wireless communication devices to establish said wireless link between them;
C) using said program to receive messages from said 2nd wireless communication device; and
D) using said program to place, in response to a message from said 2nd wireless communication device, said personal computing device in a locked state in which access to its files and application programs is prohibited or restricted.

43. The method of claim 42, additionally comprising the step of:
A) using said program to configure said 2nd wireless communication device to monitor said quality of service of said wireless link.

44. The method of claim 42, additionally comprising the steps of:
A) using said program to receive a message from said 2nd wireless communication device; and
B) placing said personal computing device in an unlocked state upon receipt of said message.

45. The method of claim 42, additionally comprising the steps of:
A) using said program to receive a message from said 2nd wireless communication device;
B) using said program to receive user inputs to said personal computing device;
C) using said program to place, in response to said message and said user input, said personal computing device in an unlocked state.

46. The method of claim 45, wherein said step of receiving user inputs comprises the step of detecting keystrokes at the keyboard or movement or clicking of the mouse associated with said personal computing device.

47. The method of claim 42, additionally comprising the steps of:
A) using said program to receive a message from said 2nd wireless communication device;
B) requesting a user to input a personal access code;
C) receiving said user input;
D) comparing said user input to the personal access code that is stored in said personal computing device; and
E) placing said personal computing device in an unlocked state if there is a match between said input and said stored personal access code.
